(19) United States
(12) Patent Application Publication
(10) Pub. No.: US 2017/0361386 A1
(43) Pub. Date: Dec. 21, 2017

(54) RECIPROCATING TOOL

(71) Applicant: TSAN-YANG LU, Taichung City (TW)

(72) Inventor: YUNG-JHONG LU, Taichung City (TW)

(21) Appl. No.: 15/396,780

(22) Filed: Jan. 2, 2017

(30) Foreign Application Priority Data
Jun. 20, 2016 (TW) 105209182

(51) Int. Cl. B23D 49/16; F16H 25/12; F16H 1/28; F16H 37/12; B27B 19/09

(52) U.S. Cl. CPC B23D 49/16; F16H 37/124; B27B 19/09; F16H 1/28; F16H 25/12

(57) ABSTRACT

A reciprocating tool employs a motor gear of a drive motor to rotate a drive shaft. When the drive shaft rotates, a sliding member disposed into a ball rolling groove will move along the path of the ball rolling groove. At the same time, for the restriction of annular fixing member, the component force of the sliding member in an axial direction pushes a driven shaft to move back and forth repeatedly along the axial direction, so that a tool fixed on the driven shaft will also back and forth repeatedly in the axial direction, and thus a high efficient reciprocating tool is achieved.

### BACKGROUND

### Field of the Invention

The invention relates to a Power tool, and more particularly to a reciprocating tool.

### Related Prior Art

Power tools can be categorized into pneumatic tools and electric tools. The power reciprocating tools sold available on the market normally employ a crankshaft to convert the rotary motion of the motor into a repeated liner motion along a specific direction. However, these conventional Power reciprocating tools have many disadvantages, for example, low speed of reciprocating motion, big energy loss in the process of energy conversion, too large invalid power and etc. Therefore, it is urgent to develop a reciprocating tool which is converting the rotary kinetic energy of a motor into a repeatedly back and forth motion along a specific direction, to improve work efficiency.

### SUMMARY

One objective of the present invention is to provide a high efficient reciprocating tool.

To achieve the above objective, the reciprocating tool in accordance with the present invention comprises:

a drive motor including a motor gear at one end of the drive motor;

a drive shaft which is rotated by the motor gear and extends along an axial direction, the drive shaft is composition of a ball rolling groove which is a rotary closed loop formed around the front end shaft, an extending direction of the ball rolling groove includes a component vector along the axial direction and a component vector around the front end shaft;

a driven shaft which is composition of a connecting end to connect a tool and an insertion section, the insertion section includes an inner round operation recess, the drive shaft is inserted into the inner round operation recess of driven shaft and rotating respect to the insertion section, the insertion section with at least one positioning surface on outer surface, and the insertion section with a ball hole;

a sliding member disposed into the ball hole of driven shaft and the ball rolling groove of drive shaft, when the drive shaft rotates, the sliding member will move along the ball rolling groove;

an annular fixing member, with at least one restricting surface on inner peripheral surface, the annular fixing member is sleeved onto the insertion section of the driven shaft, and the restricting surface is abutted against the positioning surface on driven shaft; and

a shell which is used to accommodate the drive motor, the drive shaft, the driven shaft, the sliding member, and the annular fixing member;

by means of swing arm, rotation of the drive shaft can cause movement of the sliding member along the ball rolling groove, for the restriction of annular fixing member, the driven shaft is driven to move back and forth repeatedly along the axial direction.

It can be learned from the above description that the invention employs the motor gear of the drive motor to rotate the drive shaft. When the drive shaft rotates, the sliding member disposed into the ball rolling groove will move along the path of the ball rolling groove, and at the same time, for the restriction of annular fixing member, the component of force of the sliding member in the axial direction pushes the driven shaft to move back and forth repeatedly along the axial direction, so that the tool fixed on the driven shaft also moves back and forth repeatedly in the axial direction, and thus a high efficient reciprocating tool is achieved.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is an exploded view of a reciprocating tool in accordance with a preferred embodiment of the invention;

FIG. 2 is a perspective view of the drive shaft of the reciprocating tool in accordance with the preferred embodiment of the invention;

FIG. 3 is a perspective view of the driven shaft & sliding member of the reciprocating tool in accordance with the preferred embodiment of the invention;

FIG. 4 is a perspective view of the annular fixing member of the reciprocating tool in accordance with the preferred embodiment of the invention;

FIG. 5 is a side view of the drive shaft of the reciprocating tool in accordance with the preferred embodiment of the invention;

FIG. 6 is a side view of a part of the reciprocating tool in accordance with the preferred embodiment of the invention;

FIG. 7 is another side view of a part of the reciprocating tool in accordance with the preferred embodiment of the invention;

FIG. 8 is an exploded view of a reciprocating tool in accordance with another preferred embodiment of the invention; and

FIG. 9 is an exploded view of a reciprocating tool in accordance with another preferred embodiment of the invention.

### DETAILED DESCRIPTION

The invention will be clearer from the following description when viewed together with the accompanying drawings, which show, for purpose of illustrations only, the preferred embodiment in accordance with the invention.

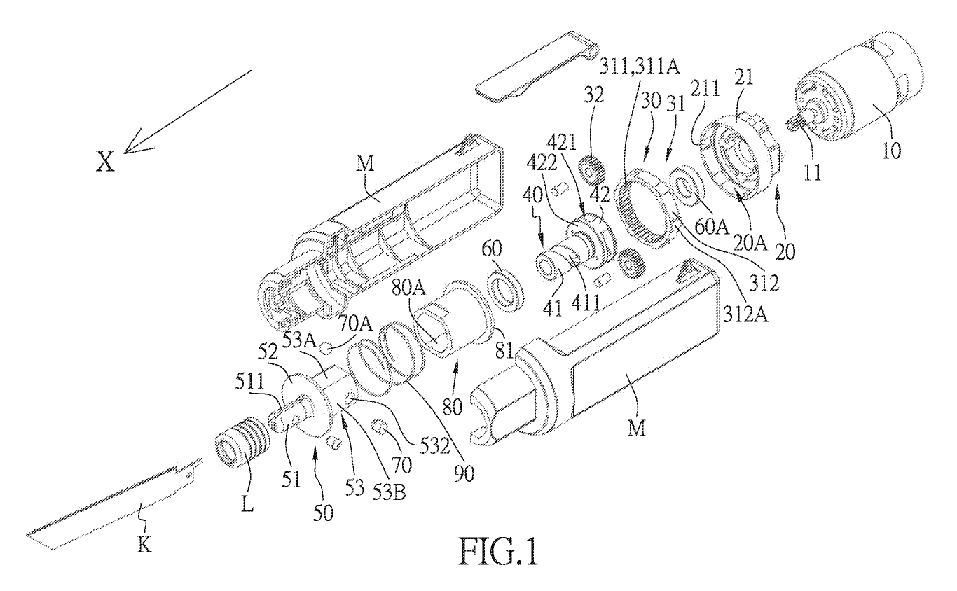

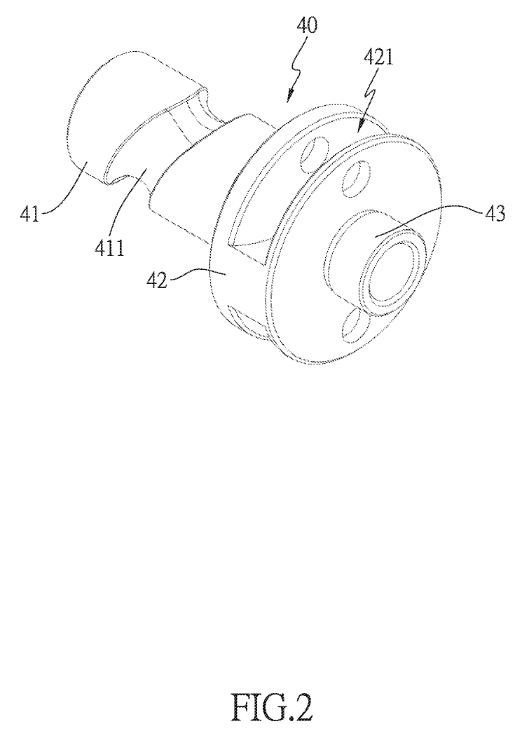

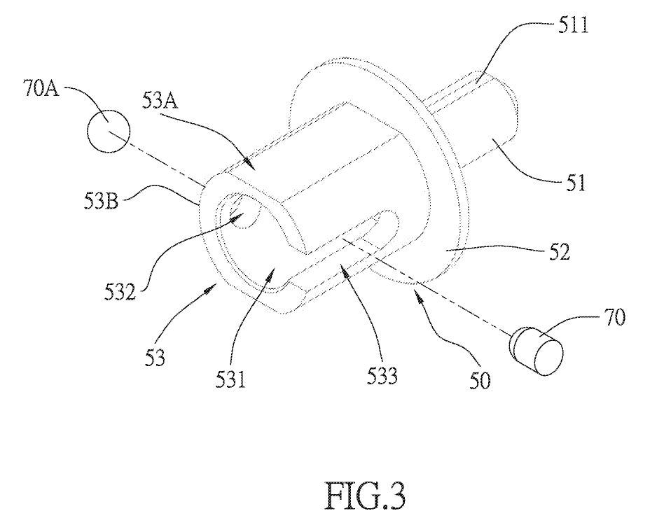

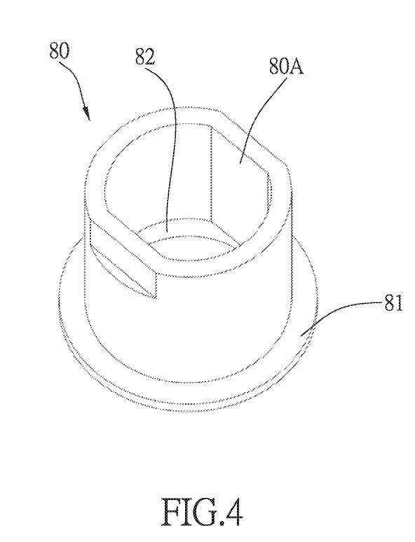

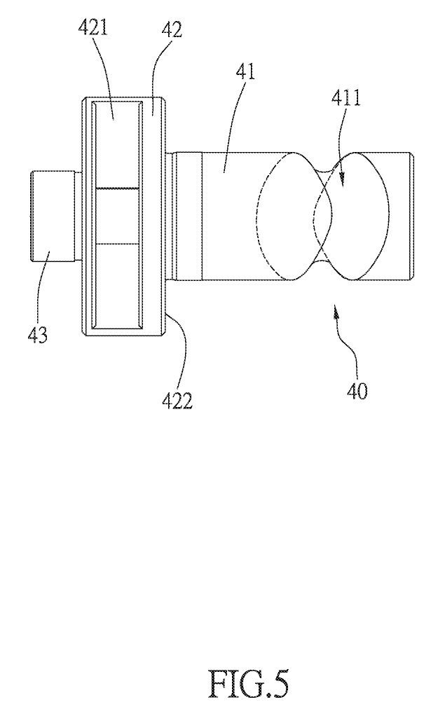

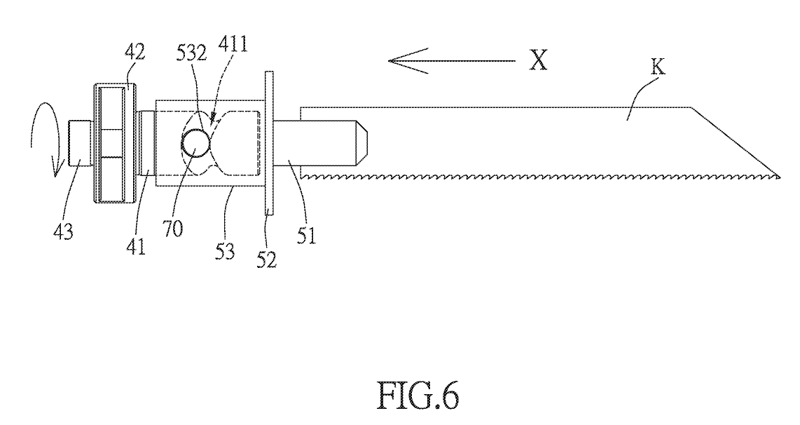

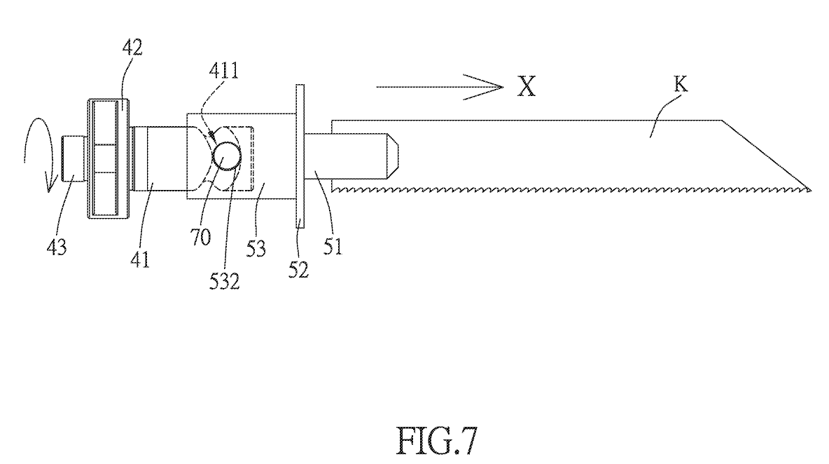

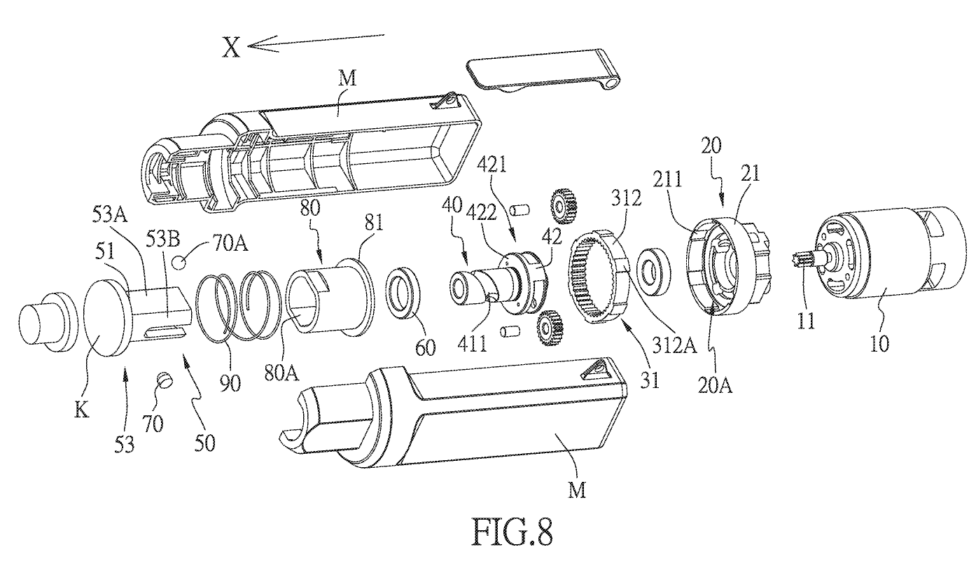

Referring to FIGS. 1-9, the reciprocating tool in accordance with the preferred embodiment of the invention comprises: a drive motor 10, a gear box 20, a gear set 30, a drive shaft 40, a driven shaft 50, two bearings 60 60A, a sliding member 70, at least one assistant sliding member 70A, an annular fixing member 80, an elastic member 90, an outer cover L, and an outer shell M.

The drive motor 10 includes a motor gear 11 at one end of the drive motor 10.

The gear box 20 is connected to the end of the drive motor 10 where the motor gear 11 is provided. The gear box 20 includes a connecting peripheral wall 21 with a plurality of spaced-apart engaging grooves 211, and the connecting peripheral wall 21 defines a receiving space 20A.

The gear set 30 includes a ring gear 31 and at least two planetary gears 32. The ring gear 31 is an annular ring disposed into the gear box receiving space 20A and includes an inner peripheral surface 311 and an opposite outer peripheral surface 312. A plurality of spaced-apart engaging ribs 312A is formed on the outer peripheral surface 312 to engage with the engaging grooves 211, so that the ring gear 31 is engaged in the gear box receiving space 20A. A plurality of drive teeth 311A is formed around the inner peripheral surface 311. The planetary gears 32 are engaged with the motor gear 11 and are disposed into and also engaged with the drive teeth 311A of the ring gear 31. In this embodiment, there are two planetary gears 32.

The drive shaft 40 is composition of a front end shaft 41, a receiving section 42 and a bearing section 43. The front end shaft 41 with a ball rolling groove 411 which is a rotary closed loop formed around the front end shaft 41. An extending direction of the ball rolling groove 411 includes a component vector along the axial direction X and a component vector around the front end shaft 41. The receiving section 42 has a diameter larger than a diameter of the front end shaft 41 and a diameter of the bearing section 43. The receiving section 42 includes at least two receiving cavities 421, and the planetary gears 32 are disposed into the receiving cavities 421 to rotate the drive shaft 40. One end of the receiving section 42 connected to the front end shaft 41 with an abutting surface 422.

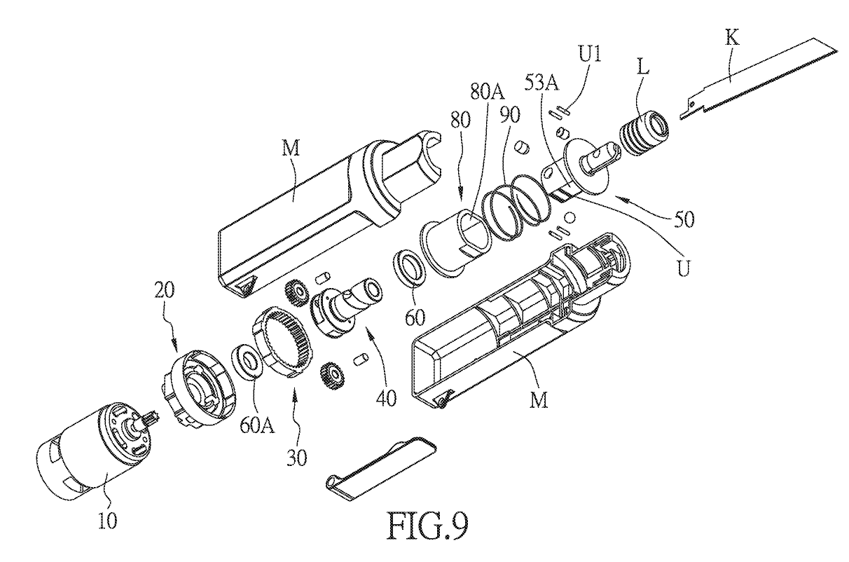

The driven shaft 50 is composition of a connecting end 51, a stop flange 52 and an insertion section 53. The connecting end 51 includes a connecting groove 511 to connect a tool K. The insertion section 53 is a hollow cylinder with an inner round operation recess 531. The front end shaft 41 of drive shaft can be inserted into the inner round operation recess 531 and rotating respect to the insertion section 53. the insertion section 53 with at least one positioning surface 53A on outer surface. The insertion section 53 with a ball hole 532 and at least one guiding slot 533 which extend along the axial direction X. The ball hole 532 and the guiding slot 533 are formed on the insertion section 53 and are not located at the positioning surface 53A. Preferably, in this embodiment, there are two positioning surfaces 53A. The insertion section 53 consists of the two spaced-apart positioning surfaces 53A and two spaced-apart arc-shaped surfaces 53B with an alternate manner on outer surface. The two arc-shaped surfaces 53B are arranged in an opposite manner. The ball hole 532 is located at one of the arc-shaped surfaces 53B, and the guiding slot 533 is located at another one of the arc-shaped surfaces 53B. In this embodiment, the tool K can be a knife tool or a hammer tool. Preferably, each of the two positioning surfaces 53A is provided with at least one cushion-roller groove U for accommodation of a cushion roller U1 as shown in FIG. 9.

The bearings 60 is sleeved onto the front end shaft 41 and abutted against the abutting surface 422. Another one bearings 60A is sleeved onto the bearing section 43, and the bearing 60A has its outer ring portion installed in the receiving space 20A. With the two bearings 60 60A, the drive shaft 40 is capable of rotating with respect to the driven shaft 50. When the drive shaft 40 is rotated by the drive motor 10, the driven shaft 50 won't rotate synchronously with the drive shaft 40, for the restriction of annular fixing member.

The sliding member 70 is disposed into the ball hole 532 and the ball rolling groove 411. When the drive shaft 40 rotates, the sliding member 70 will move annularly along the ball rolling groove 411. Since the extending direction of the ball rolling groove 411 includes a component along the axial direction X and a component around the front end shaft 41, when the sliding member 70, moving annularly along the ball rolling groove 411, will produce a component of force along the axial direction X and a component of force around the drive shaft 40. Besides, the driven shaft 50 does not rotate with the drive shaft 40, for the restriction of annular fixing member, therefore, the sliding member 70 located in the ball hole 532 is only able to transmit the component of force in the axial direction X to the driven shaft 50, which will cause reciprocating displacement of the driven shaft 50 along the axial direction X with respect to the drive shaft 40. In this embodiment, the sliding member 70 can be a rolling ball or, a cylinder with a round end or arc-shaped end.

The at least one assistant sliding member 70A is disposed into the guiding slot 533, each guiding slot 533 is provided with at least one assistant sliding member 70A, so that the driven shaft 50 can move more smoothly in the axial direction X and can be prevented from arbitrary rotation. In this embodiment, the assistant sliding member 70A can be a rolling ball or, a cylinder with a round end or arc-shaped end.

The annular fixing member 80 is a hollow cylinder, with at least one restricting surface 80A on inner round surface. The annular fixing member 80 is sleeved onto the insertion section 53 on the driven shaft 50, and the restricting surface 80A is abutted against the positioning surface 53A to prevent the driven shaft 50 from rotating, which can also prevent the sliding member 70 falling off from the ball hole 532, and prevent the assistant sliding member 70A falling off from the guiding slot 533. Besides, when the driven shaft 50 moves, the cushion roller U1 between the restricting surface 80A and positioning surface 53A to enhance the smoothness of movement of the driven shaft 50 while reducing friction caused loss. Preferably, the annular fixing member 80 with an annular abutting flange 81, which is located at one end of the annular fixing member 80 toward the receiving section 42. The annular fixing member 80 includes an inner hole 82, to locate outer ring surface of the bearing 60, the bearing 60 sleeved onto the front end shaft 41.

The elastic member 90 is sleeved on the annular fixing member 80, and has two ends pushed against the annular abutting flange 81 and the stop flange 52, respectively, to eliminate the interval between the sliding member 70 and the ball rolling groove 411.

The outer cover L is sleeved onto the connecting end 51 to make sure the tool K is inserted stably and firmly in the connecting groove 511.

The shell M is used to accommodate the drive motor 10, the gear box 20, the gear set 30, the drive shaft 40, the driven shaft 50, the two bearings 60 60A, the sliding member 70, the assistant sliding member 70A, the annular fixing member 80, and the elastic member 90.

What mentioned above are the main components of the reciprocating tool in the invention, and for a better understanding of the operation and function of the embodiment of the invention, reference the following description with FIGS. 1-9.

When in use, the motor gear 11 of the drive motor 10 rotates the planetary gears 32, and then the planetary gears 32 transmit kinetic energy to the drive shaft 40 to cause rotation of the drive shaft 40. When the drive shaft 40 rotates, the sliding member 70 disposed into the ball rolling groove 411 will move along the path of the ball rolling groove 411, and at the same time, for the restriction of annular fixing member, the component force of the sliding member 70 in the axial direction X pushes the driven shaft 50 to move back and forth repeatedly along the axial direction, so that the tool K fixed on the driven shaft 50 also moves back and forth repeatedly in the axial direction X.

There is a gear reducing system at the reciprocating tool of the invention. The gear set 30 between the drive shaft 40 and the drive motor 10, It makes the lower speed output of the drive shaft 40 than the speed of drive motor 10, so as to stabilize the speed of the back and forth motion of the driven shaft 50.

Besides, the annular fixing member 80 with the at least one restricting surface 80A on the inner peripheral surface, to abut against the at least one positioning surface 53A on the outer peripheral surface of the insertion section 53, so as to prevent the driven shaft 50 from rotating.

Furthermore, the ball rolling groove 411 is in the form of a rotary closed loop, which allows the sliding member 70 to circulate along the ball rolling groove 411, so that the driven shaft 50 can move back and forth repeatedly along the axial direction X.

While we have shown and described various embodiments in accordance with the invention, it is clear to those skilled in the art that further embodiments may be made without departing from the scope of the present invention.

What is claimed is:

1. A reciprocating tool, characterized in that the reciprocating tool comprises:
a drive motor including a motor gear at one end of the drive motor;
a drive shaft which is rotated by the motor gear and extends along an axial direction, the drive shaft is provided with a ball rolling groove which is in the form of a rotary closed loop formed around the front end shaft, an extending direction of the ball rolling groove includes a component vector along the axial direction and a component vector around the front end shaft;
a driven shaft which is composition of a connecting end and an insertion section, the connecting end to connect a tool, the insertion section includes an inner round operation recess, the drive shaft is inserted into the inner round operation recess and capable of rotating respect to the insertion section, the insertion section with at least one positioning surface on outer surface, and the insertion section with a ball hole;
a sliding member disposed into the ball hole and the ball rolling groove, when the drive shaft rotates, the sliding member will move along the ball rolling groove;
an annular fixing member, with at least one restricting surface on inner round surface, the annular fixing member is sleeved onto the insertion section of the driven shaft, and the restricting surface is abutted against the positioning surface; and
a shell which is used to accommodate the drive motor, the drive shaft, the driven shaft, the sliding member, and the annular fixing member;
by means of swing arm, rotation of the drive shaft can cause movement of the sliding member along the ball rolling groove, so that the driven shaft is driven to move back and forth repeatedly along the axial direction.

2. The reciprocating tool as claimed in claim 1 further comprising:
a gear box which is connected to the end of the drive motor where the motor gear is provided, the gear box includes a connecting peripheral wall which is provided with a plurality of spaced-apart engaging grooves, and the connecting peripheral wall defines a receiving space;
a gear set including a ring gear and at least two planetary gears, the ring gear is an annular ring disposed in the receiving space and includes an inner peripheral surface and an opposite outer peripheral surface, a plurality of spaced-apart engaging ribs is formed on the outer peripheral surface to engage with the engaging grooves, a plurality of drive teeth is formed around the inner peripheral surface, the planetary gears are engaged with the motor gear and are disposed in and also engaged with the drive teeth of the ring gear;
the drive shaft is composition of a front end shaft and a receiving section, the front end shaft is provided with the ball rolling groove, the front end shaft is inserted in the inner operation recess and capable of rotating respect to the insertion section, the receiving section includes at least two receiving cavities, and the planetary gears are disposed in the receiving cavities.

3. The reciprocating tool as claimed in claim 2, wherein a stop flange on driven shaft between the connecting end and the insertion section, the annular fixing member with an annular abutting flange which is located at one end of the annular fixing member toward the driven shaft receiving section, and an elastic member between the annular fixing member and driven shaft, It has two ends pushed against the annular abutting flange and the stop flange, respectively.

4. The reciprocating tool as claimed in claim 2, wherein the insertion section with at least one guiding slot which extends along the axial direction, at least one assistant sliding member is disposed into the guiding slot, and each said guiding slot with one said assistant sliding member.

5. The reciprocating tool as claimed in claim 2, wherein the drive shaft with a bearing section along the axial direction which is connected to the receiving section, one bearing is sleeved onto the front end shaft and another bearing is sleeved onto the bearing section.

6. The reciprocating tool as claimed in claim 1 further comprising an outer cover sleeved onto the connecting end.

7. The reciprocating tool as claimed in claim 1, wherein the connecting end of driven shaft with a connecting groove for insertion of the tool.

8. The reciprocating tool as claimed in claim 4, wherein there are two said positioning surfaces, the outer surface of the insertion section consists of the two spaced-apart positioning surfaces and two spaced-apart arc-shaped surfaces which arranged in an alternate manner, the two arc-shaped surfaces are arranged in an opposite manner, the ball hole is located at one of the arc-shaped surfaces, and the guiding slot is located at another one of the arc-shaped surfaces.

9. The reciprocating tool as claimed in claim 2, wherein a quantity of the planetary gears is two.

10. The reciprocating tool as claimed in claim 1, wherein each of the two positioning surfaces of driven shaft is provided with at least one cushion-roller groove for accommodation of a cushion roller which comes into contact with the restricting surfaces.
